(19) United States
(12) Patent Application Publication
(10) Pub. No.: US 2019/0151186 A1
(43) Pub. Date: May 23, 2019

(54) Universal Walker Seat

(71) Applicant: Scott Andrew Bonis, Livingston, TX (US)

(72) Inventor: Scott Andrew Bonis, Livingston, TX (US)

(21) Appl. No.: 16/253,637

(22) Filed: Jan. 22, 2019

Related U.S. Application Data
(63) Continuation-in-part of application No. 16/054,915, filed on Aug. 3, 2018.
(60) Provisional application No. 62/540,808, filed on Aug. 3, 2017.

(51) Int. Cl. A61H 3/04

(52) U.S. Cl. CPC A61H 3/04; A61H 2201/0157; A61H 2201/0149

(57) ABSTRACT

The universal walker seat is an apparatus that supports a user while standing and sitting. The apparatus allows a user to sit if the user is too weak or tired to continue walking. The apparatus includes a folding walker, at least one suspending sheet, and a set of fasteners. The folding walker allows a user to redistribute weight while walking in order to ease the stress of walking on whichever body part is not strong enough to support the user. The at least one suspending sheet safely and comfortably supports a user while sitting with the folding walker. The at least one suspending sheet hangs from the folding walker with the set of fasteners. The set of fasteners allows the at least one suspending sheet to be attached to a variety of folding walkers and remain attached to a folding walker regardless if the folding walker is extended or collapsed.

The current application is a continuation-in-part (CIP) application of a U.S. non-provisional application Ser. No. 16/054,915 filed on Aug. 3, 2018. The U.S. non-provisional application Ser. No. 16/054,915 claims a priority to a U.S. provisional application Ser. No. 62/540,808 filed on Aug. 3, 2017.

### FIELD OF THE INVENTION

The present invention generally relates to walker accessories. More specifically, the present invention is a universal walker seat.

### BACKGROUND OF THE INVENTION

Presently, walkers are simply foldable walkers or seated walkers with fixed seats. Foldable walkers offer limited support as foldable walkers do not accommodate a user if he or she needs to sit. Seated walkers support a user while sitting and walking, however, current seated walkers occupy too much space while in use and in storage. Seated walkers are also cumbersome to use due to the amount of space occupied by the fixed seat and seat itself being fixed.

It is therefore an objective of the present invention to effectively support a user while standing and sitting while minimizing the amount of space occupied by the present invention. The present invention facilitates the sitting and standing of the user with a variety of folding walkers. Moreover, the present invention comprises a folding walker, at least one suspending sheet, and a set of fasteners. Unlike typical standard walkers, the at least one suspending sheet is flexible and collapsible, allowing the user to quickly sit or walk freely with the present invention. Moreover, the at least one suspending sheet may remain attached to the folding walker while in a collapsed configuration. The at least one suspending sheet is preferably canvas with an extensive mesh structure in order to effectively support the weight of a variety of users and a variety of items. The present invention further enhances the safety of the user as the present invention accommodates a flashlight and orients the flashlight towards the path of the user with the present invention.

### BRIEF DESCRIPTION OF THE DRAWINGS

FIG. 1 is a rear perspective view of the present invention with a first sheet and a second sheet hanging from both a first leg assembly and a second leg assembly.

FIG. 2 is an enlarged view of the present invention with the first sheet and the second sheet attached to the folding walker with a set of first fasteners and a set of second fasteners, respectively.

FIG. 3 is a rear perspective view of the present invention with the first sheet hanging from the first leg assembly and the second sheet hanging from the second leg assembly.

FIG. 4 is a rear perspective view of the present invention with the first sheet hanging from the first leg assembly and the second leg assembly.

FIG. 5 is a rear perspective view of the present invention with the second sheet hanging from the first leg assembly and the second leg assembly.

FIG. 6 is a rear perspective view of the present invention with the first sheet hanging from the first leg assembly.

FIG. 7 is a rear perspective view of the present invention with the second sheet hanging from the second leg assembly.

FIG. 8 is a rear perspective view of the present invention with the second sheet hanging from the first leg assembly.

FIG. 9 is a rear perspective view of the present invention with the first sheet hanging from the second leg assembly.

FIG. 10 is a rear perspective view of the present invention with the first sheet hanging from the first leg assembly and the second leg assembly, and the second sheet hanging from the first leg assembly.

FIG. 11 is a rear perspective view of the present invention with the first sheet hanging from the first leg assembly and the second leg assembly, and the second sheet hanging from the second leg assembly.

FIG. 12 is a rear perspective view of the present invention with the first sheet hanging from the first leg assembly and the second leg assembly and a storage sheet connected to the first sheet.

FIG. 13 is a rear perspective view of the present invention with the first sheet hanging from the first leg assembly and the second leg assembly and a storage sheet and a sleeve connected to the first sheet, wherein the sleeve is positioned adjacent a second edge.

FIG. 14 is a rear perspective view of the present invention with the first sheet hanging from the first leg assembly and the second leg assembly and a storage sheet and a sleeve connected to the first sheet, wherein the sleeve is positioned adjacent a first edge.

FIG. 15 is a rear perspective view of the present invention with the first sheet hanging from the first leg assembly and the second leg assembly and a sleeve connected to the first sheet, wherein the sleeve is positioned adjacent a first edge.

FIG. 16 is a rear perspective view of the present invention with the first sheet hanging from the first leg assembly and the second leg assembly and a sleeve connected to the first sheet, wherein the sleeve is positioned adjacent a first edge.

FIG. 17 is a rear perspective view of the present invention with the first sheet hanging from the first leg assembly, the second sheet hanging from the second leg assembly, and the folding walker in a collapsed configuration.

FIG. 18 is a rear perspective view of the present invention with a first sheet hanging from both a first leg assembly and a second leg assembly and a plurality of stabilizing panels traversing across the first sheet in a collapsed configuration.

FIG. 19 is a bottom perspective view of the present invention with a first sheet hanging from both a first leg assembly and a second leg assembly and a plurality of stabilizing panels traversing across the first sheet.

FIG. 20 is a rear perspective view of the present invention with a second sheet hanging from both a first leg assembly and a second leg assembly and a plurality of stabilizing panels traversing across the first sheet in a collapsed configuration.

FIG. 21 is a bottom perspective view of the present invention with a second sheet hanging from both a first leg assembly and a second leg assembly and a plurality of stabilizing panels traversing across the second sheet.

FIG. 22 is an enlarged view of the connection of the first sheet with the first leg assembly and a plurality of stabilizing panels traversing across the first sheet of present invention, wherein the first sheet is secured to the second leg and the brace with a first front fastener, a first rear fastener, a second front fastener, a second rear fastener, a first tab, and a second tab.

FIG. 23 is an enlarged view of the connection of the second sheet with the second leg assembly and a plurality of stabilizing panels traversing across the second sheet of present invention, wherein the second sheet is secured to the second leg and the brace with a third front fastener, a third rear fastener, a fourth front fastener, a fourth rear fastener, a third tab, and a fourth tab.

FIG. 24 is an enlarged view of the first sheet collapsed along the brace of present invention, wherein the first sheet is secured to the brace with at least one first elongated band and a third fastener.

FIG. 25 is an enlarged view of the second sheet collapsed along the brace of present invention, wherein the second sheet is secured to the brace with at least one second elongated band and a fourth fastener.

### DETAIL DESCRIPTIONS OF THE INVENTION

All illustrations of the drawings are for the purpose of describing selected versions of the present invention and are not intended to limit the scope of the present invention.

The present invention is a universal walker seat that allows a user to sit with a walker and attaches to a variety of walkers. The present invention comprises a folding walker 1, at least one suspending sheet 10, and a set of fasteners 20. The folding walker 1 upholds a user. The folding walker 1 aids the user in maintaining a standing position while walking. The folding walker 1 is preferably collapsible. In order for the folding walker 1 to uphold a user and be collapsible, the folding walker 1 comprises a first leg 4 assembly 2, a second leg assembly 3, a brace 7, a first armrest 8, and a second armrest 9. The first leg assembly 2 and the second leg assembly 3 support the first armrest 8 and the second armrest 9, respectively. The first leg assembly 2 and the second leg assembly 3 also uphold the at least one suspending sheet 10. The brace 7 connects the first leg assembly 2 and the second leg assembly 3 with each other. The first armrest 8 and the second armrest 9 both allow the user to mount himself or herself onto the present invention while walking.

The user may safely and comfortably sit on the present invention with the at least one suspending sheet 10. The at least one suspending sheet 10 may remain connected to the folding walker 1 while in a collapsed configured and may store a variety of items that are typically necessary or used by users with the folding walker 1 as the at least one suspending sheet 10 is flexible. Because the at least one suspending sheet 10 may remain attached to the folding walker 1 while in the collapsed configuration, the present invention facilitates storage and transportation and the set of fasteners 20 do not need to be removed unless the user wishes to separate the at least one suspending sheet 10 from the folding walker 1 for any reason. In the preferred embodiment of the present invention, the at least one suspending sheet 10 comprises canvas material. More specifically, the at least one suspending sheet 10 comprises canvas material with an extensive mesh structure in order to accommodate the weight of a variety of users while remaining flexible. It is understood that alternate embodiments of the present invention may comprise at least one suspending sheet 10 with a variety of supportive and flexible materials. The at least one suspending sheet 10 comprises a sheet body 11, a first edge 12, a second edge 13, a plurality of first holes 14, and a plurality of second holes 15. The sheet body 11 supports and cradles the user while the user sits on the at least one suspending sheet 10. The first edge 12 and the second edge 13 define the width of the sheet body 11. Moreover, the first edge 12 and the second edge 13 are oppositely positioned of each other across the sheet body 11. The plurality of first holes 14 and the plurality of second holes 15 allows the set of fasteners 20 to connect with the at least one suspending sheet 10 while preserving the structural integrity of the sheet body 11. The set of fasteners 20 connects the at least one suspending sheet 10 to the folding walker 1. Moreover, the set of fasteners 20 allows at least one suspending sheet 10 to be easily attached and removed from the folding walker 1. The set of fasteners 20 is preferably S-hooks. However, alternate embodiments of the present invention may comprise a variety of fasteners that securely connect the at least one suspending sheet 10 with the foldable walker while being readily removable. An alternate embodiment of the present invention may comprise a set of fasteners 20 with locking mechanism such that the set of fasteners 20 is further secured to the folding walker 1 and only separable from the folding walker 1 manually by the user. Such a fastener is a hook and hook turnbuckle. This alternate embodiment allows the at least one suspending sheet 10 to be lowered and raised as the length of the set of fasteners 20 is adjustable with the set of fasteners 20 being hook and hook turnbuckles.

The overall arrangement of the aforementioned components allows the present invention to attach to a variety of folding walkers and uphold a user while sitting and walking in a standing position. The first armrest 8 is mounted onto the first leg assembly 2. Similarly, the second armrest 9 is mounted onto the second leg assembly 3. This arrangement allows the user to easily grasp onto the first armrest 8 and the second armrest 9, respectively, while in a standing position. The first leg assembly 2 is foldably connected to the brace 7. Moreover, the second leg assembly 3 is foldably connected to the brace 7, opposite the first leg assembly 2, thereby allowing the folding walker 1 to effectively support the user while sitting and walking. This arrangement facilitates the storing of the present invention by allowing the folding walker 1 to collapse about the brace 7. In order for the set of fasteners 20 to connect the at least one suspending sheet 10 to the folding walker 1, the plurality of first holes 14 and the plurality of second holes 15 traverse through the sheet body 11. In order for the sheet body 11 to traverse the entire length of the brace 7, the plurality of first holes 14 is distributed along the first edge 12 of the sheet body 11, and the second holes 15 is distributed along the second edge 13 of the sheet body 11. Moreover, the set of fasteners 20 is coupled to the plurality of first holes 14 and the plurality of second holes 15, and the sheet body 11 is attached to the folding walker 1 with the set of fasteners 20.

The folding walker 1 is able to support a user in a standing and sitting position as the first leg assembly 2 and the second leg assembly 3 each comprises a first leg 4, a second leg 5, and a support bar 6. The first leg 4 and the second leg 5 of the first leg assembly 2 uphold the first armrest 8. The first leg 4 preferably comprises a wheel and the second leg 5 preferably comprises a foot in order to protect the structural integrity of the second leg 5 against the ground. Furthermore, the second leg 5 preferably comprises a glide that covers the foot or replaces the foot. The glide encourages the smooth and continuous movement of the present invention against the ground. It is understood that various embodiments may comprise attachments such as friction-inducing cap or a friction-inducing foot. The first leg 4 and the second leg 5 each comprises at least two tubes that are telescopically engaged with each other in order to adjust the height of the folding walker 1. Similarly, the first leg 4 and the second leg 5 of the second leg assembly 3 upholds the second armrest 9. The support bar 6 supports the set of fasteners 20 and positions the set of fasteners 20 along the corresponding first leg 4 and the corresponding second leg 5. In order to for the support bar 6 to effectively support and uphold the set of fasteners 20, the first leg 4 is terminally fixed to the support bar 6. Similarly, the second leg 5 is terminally fixed to the support bar 6, opposite the first leg 4. The sheet body 11 is parallel to the ground and prevents the user from slipping off the sheet body 11 as the support bar 6 is oriented perpendicular to the first leg 4 and the second leg 5. More specifically, support bar 6 of the first leg assembly 2 is positioned offset from the first armrest 8, and the support bar 6 of the second leg assembly 3 is positioned offset from the second armrest 9. This arrangement positions the at least one suspending sheet 10 along the first leg assembly 2 and the second leg assembly 3 such that the user may easily sit on the sheet body 11.

Alternate embodiments may comprise more than one support bar 6. More specifically, alternate embodiments may comprise a first support bar and a second support bar. The first support bar may be positioned adjacent the first armrest 8, and the second support bar is positioned adjacent the first support bar, opposite the first arm rest 8. The at least one suspending sheet 10 may suspend from the first support bar of the first leg assembly 2 and the second leg assembly 3 with the set of fasteners 20 if the user is tall or cannot sit that far down. The at least one suspending sheet 10 may suspend from the second support bar with the set of fasteners 20 from the second support bar of the first leg assembly 2 and the second leg assembly 3 if the user wishes to be closer to the ground.

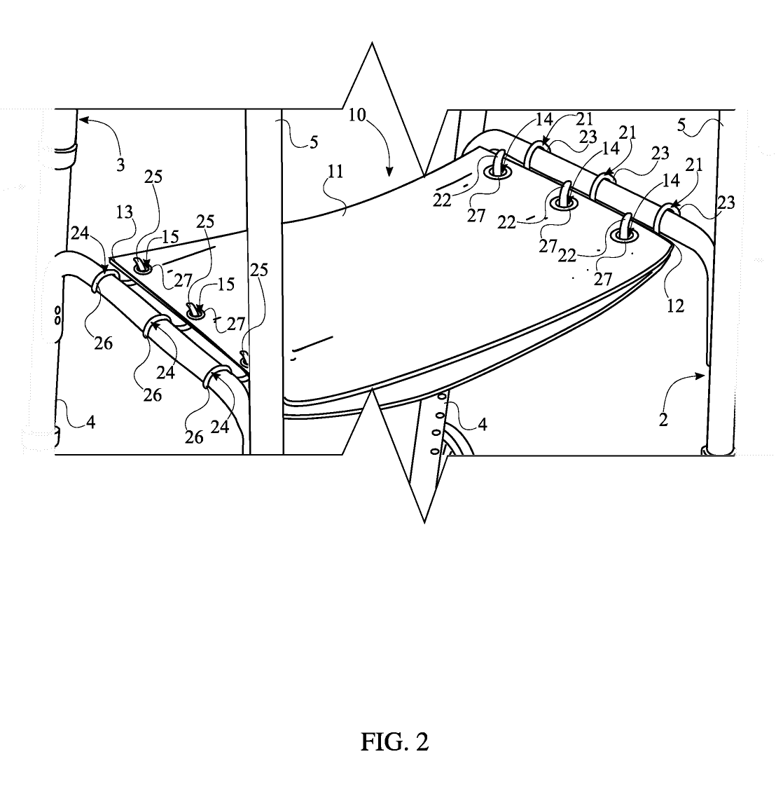

In order for at least one suspending sheet 10 to securely uphold a user while the user sits on the sheet body 11, the present invention further comprises a plurality of grommets 27, seen in FIG. 2. The plurality of grommets 27 reinforces the plurality of first holes 14 and the plurality of second holes 15 and prevents the set of fasteners 20 from tearing the plurality of first holes 14 and the plurality of second holes 15. The plurality of grommets 27 is mounted onto the sheet. Each grommet of the plurality of grommets 27 is perimetrically positioned around a corresponding first hole of the plurality of first holes 14. Similarly, each grommet of the plurality of grommets 27 is perimetrically positioned around a corresponding second hole of the plurality of second holes 15. In alternate embodiments of the present invention, the present invention may comprise a plurality of first grommets 27 and a plurality of second grommets 27 that correspond to the plurality of first holes 14 and the plurality of second holes 15, respectively.

The present invention allows the at least one suspending sheet 10 to be arranged into a variety of configurations with the folding walker 1. In order for the at least one suspending sheet 10 to be in a stored configuration with the folding walker 1 in a collapsed configuration, the set of fasteners 20 comprises a plurality of first fasteners 21 and a plurality of second fasteners 24. The plurality of first fasteners 21 connects the at least one suspending sheet 10 in a collapsed configuration with the first leg assembly 2. The plurality of first fasteners 21 is connected to the at least one suspending sheet 10 as a proximal end 22 of each first fastener of the plurality of first fasteners 21 is coupled to a corresponding hole of the plurality of first holes 14 and a corresponding hole of the plurality of second holes 15. The plurality of first fasteners 21 is connected to the folding walker 1 as a distal end 23 of each first fastener is coupled to a support bar 6 of the first leg assembly 2.

Similarly, the plurality of second fasteners 24 connects the at least one suspending sheet 10 in the stored configuration and a variety of other configurations with the second leg assembly 3. The plurality of second fasteners 24 is connected to the at least one suspending sheet 10 as a proximal end 25 of each second fastener is coupled to a corresponding hole of the plurality of first holes 14 and a corresponding hole of the plurality of second holes 15. The plurality of second fasteners 24 is connected to the folding walker 1 as a distal end 26 of each second fastener is coupled to a support bar 6 of the second leg assembly 3.

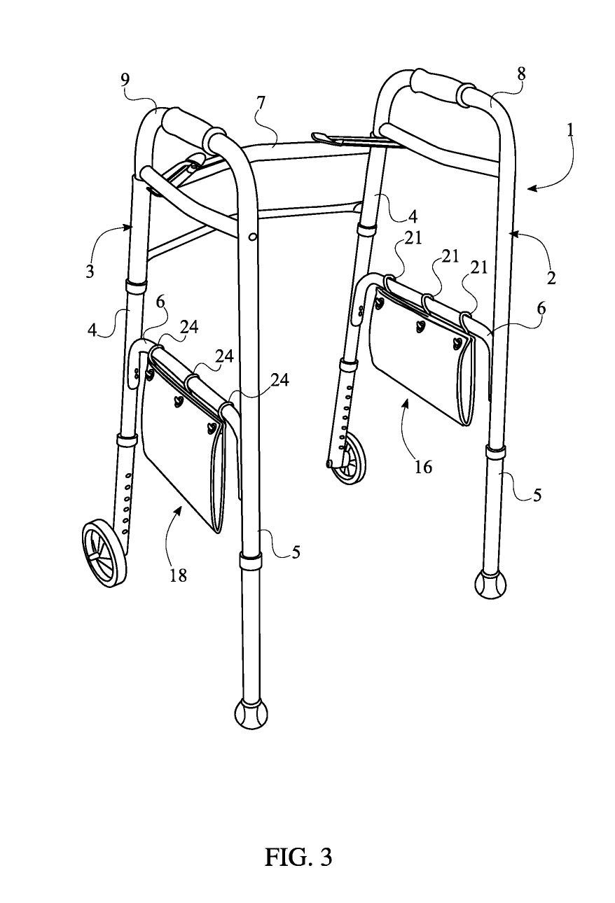

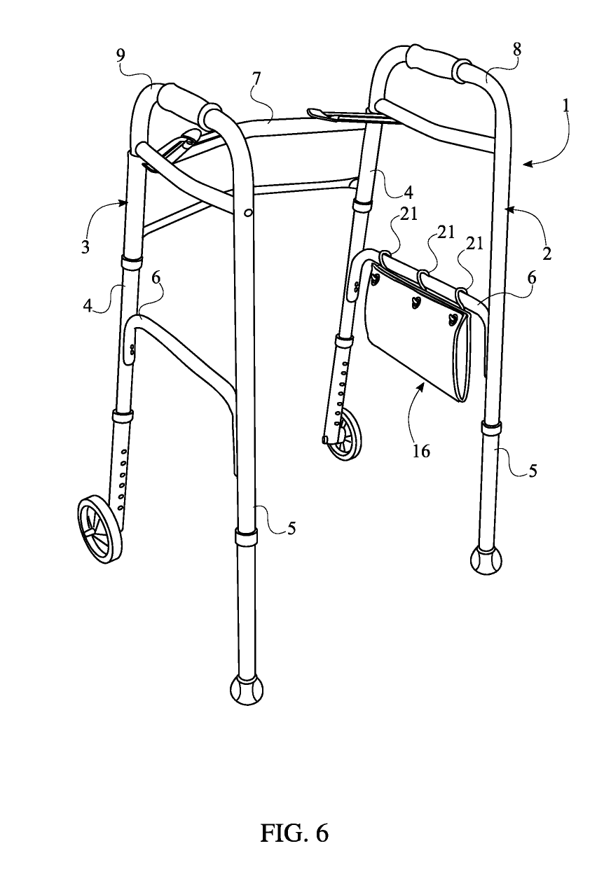

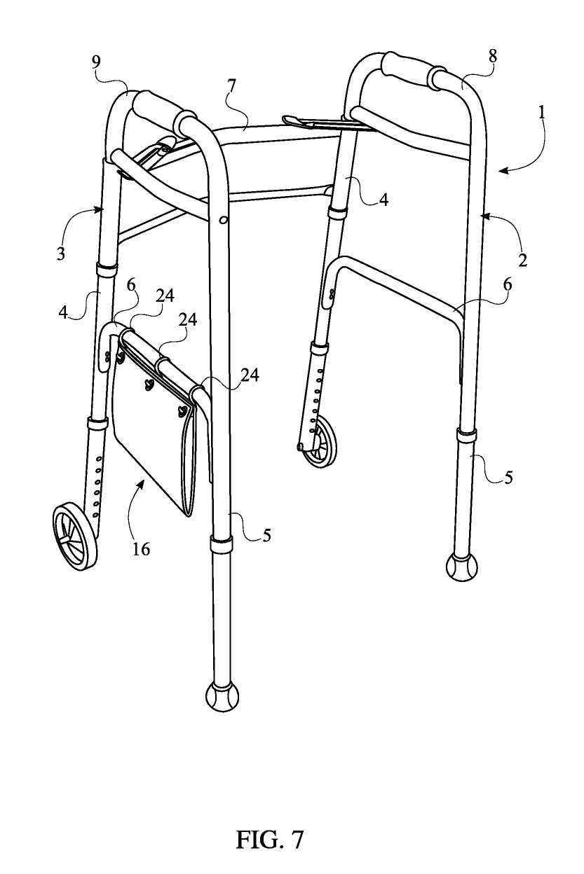

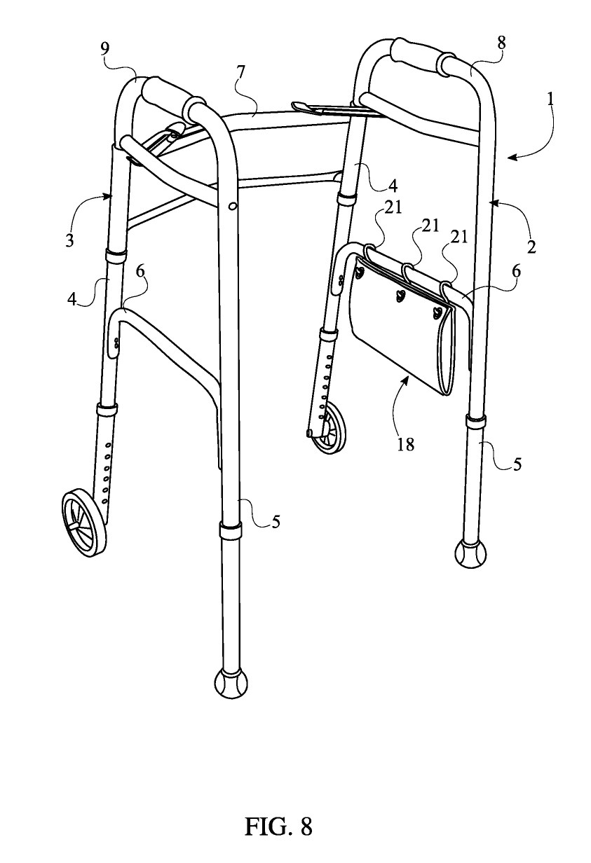

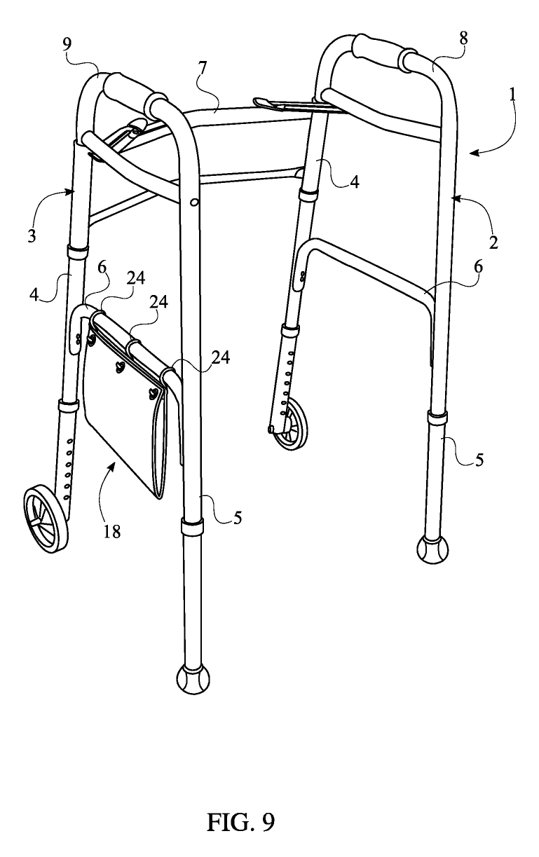

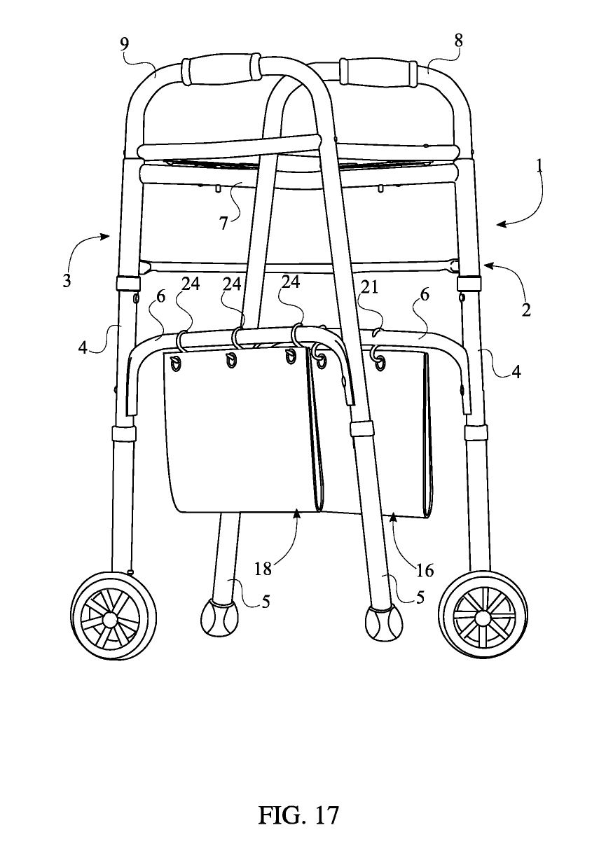

In a first embodiment of the present invention the at least one suspending sheet 10 is a first sheet 16. In a second embodiment of the present invention the at least one suspending sheet 10 is a second sheet 18. The first sheet 16 suspends the user, and the second sheet 18 suspends a variety of items such as magazines, wallets, and other items that may need to be stored while using the user sits and stands. While in a storage configuration, the first sheet 16 is collapsed, as the first sheet 16 may hang from either the support bar 6 of the first leg assembly 2, seen in FIG. 6, with the plurality of first fasteners 21 and the support bar 6 of the second leg assembly 3 with the plurality of first fasteners 21, seen in FIG. 7, with the plurality of second fasteners 24. Similarly, while in a storage configuration, the second sheet 18 is collapsed, as the second sheet 18 may hang from either the support bar 6 of the first leg assembly 2, seen in FIG. 8, with the plurality of first fasteners 21, and the support bar 6 of the second leg assembly 3 with the plurality of second fasteners 24, as seen in FIG. 9. Both the first sheet 16 and the second sheet 18 may also be in the stored configuration and collapsed simultaneously, as the first sheet 16 and the second sheet 18 may either hang from the support bar 6 of the first leg assembly 2 and the support bar 6 of the second leg assembly 3 with the plurality of first fasteners 21, as seen in FIG. 3 and FIG. 17. More specifically, the plurality of first fasteners 21 may suspend the second sheet 18 from the first leg assembly 2, and the plurality of second fasteners 24 may suspend the first sheet 16 from the second leg assembly 3.

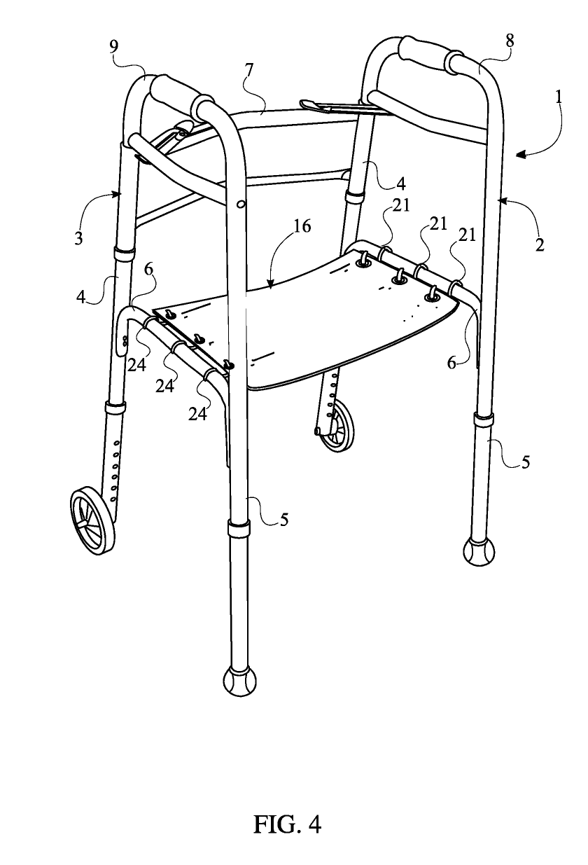

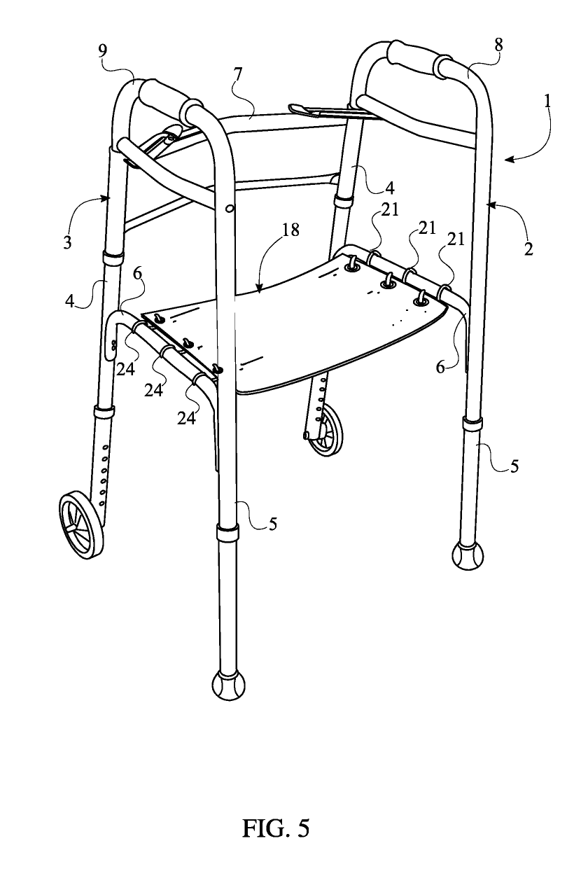

In order for the at least one suspending sheet 10 to be in an expanded configuration with the folding walker 1, the set of fasteners 20 comprises a plurality of first fasteners 21 and a plurality of second fasteners 24. In this configuration, seen in FIG. 4 and FIG. 5, a proximal end 22 of each first fastener of the plurality of first fasteners 21 is coupled to a corresponding hole of the plurality of first holes 14, and a proximal end 25 of each second fastener of the plurality of second fasteners 24 is coupled to a corresponding hole of the plurality of second holes 15. This arrangement connects the plurality of first fasteners 21 and the plurality of second fasteners 24 to the at least one suspending sheet 10. In order to connect the at least one suspending sheet 10 to the folding walker 1, a distal end 23 of the plurality of first fasteners 21 is coupled to a support bar 6 of the first leg assembly 2, and a distal end 26 of each second fastener is couple to a support bar 6 of the second leg assembly 3. In a third embodiment of the present invention, the at least one suspending sheet 10 is a first sheet 16, seen in FIG. 4. In a fourth embodiment of the present invention, the at least one suspending sheet is a second sheet 18, seen in FIG. 5. Thought the second sheet 18 typically upholds a variety of items, the second sheet 18 may also be utilized as a seat by the user according to the discretion of the user. The first sheet 16 supports and upholds a user that sits on the sheet body 11. Similarly, the second sheet 18 supports and upholds a user that sits on the sheet body 11.

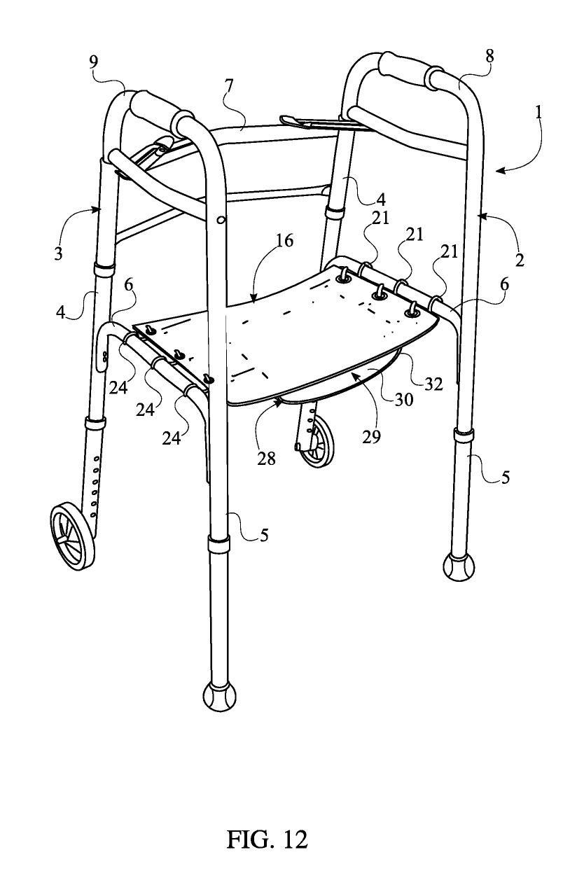

While in the expanded configuration, the at least one suspending sheet 10 traverses from the first leg assembly 2 to the second leg assembly 3 and is supported by both the plurality of first fasteners 21 and the plurality of second fasteners 24. In a fifth embodiment of the present invention, the present invention further comprises a storage sheet 28, an opening 29, and a storage compartment 30, seen in FIG. 12. The storage sheet 28 upholds a variety of items that may be stored by the user. The opening 29 allows the user to access items being upheld by the storage sheet 28. The storage compartment 30 surrounds and contains the variety of items that may be stored by the user. In order to surround the variety of items, the storage sheet 28 is perimetrically connected to the first sheet 16. The variety of items are accessible as the opening 29 is delineated by a front edge 17 of the first sheet 16 and a front edge 32 of the storage sheet 28. The variety of items are effectively contained as the storage compartment 30 is delineated by the opening 29, the sheet body 11 of the first sheet 16, and a sheet body 11 of the storage sheet 28.

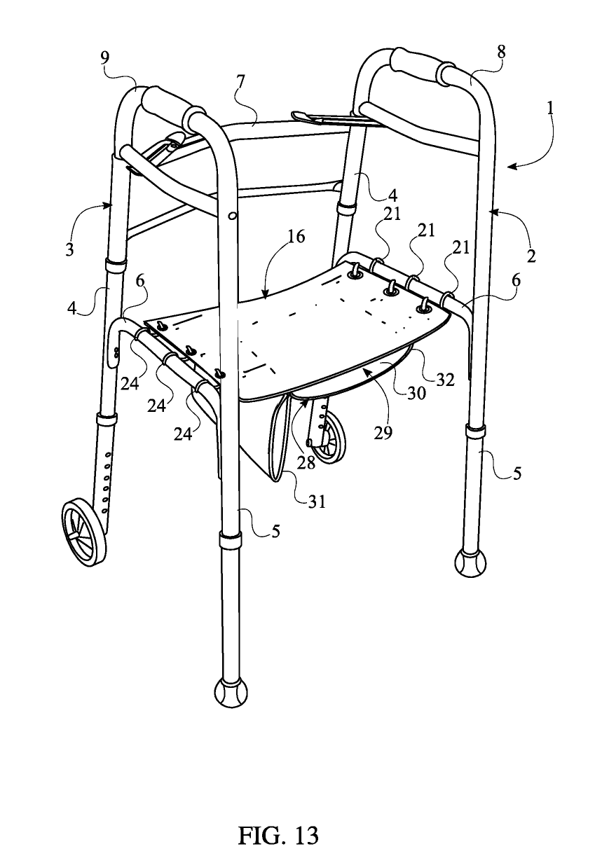

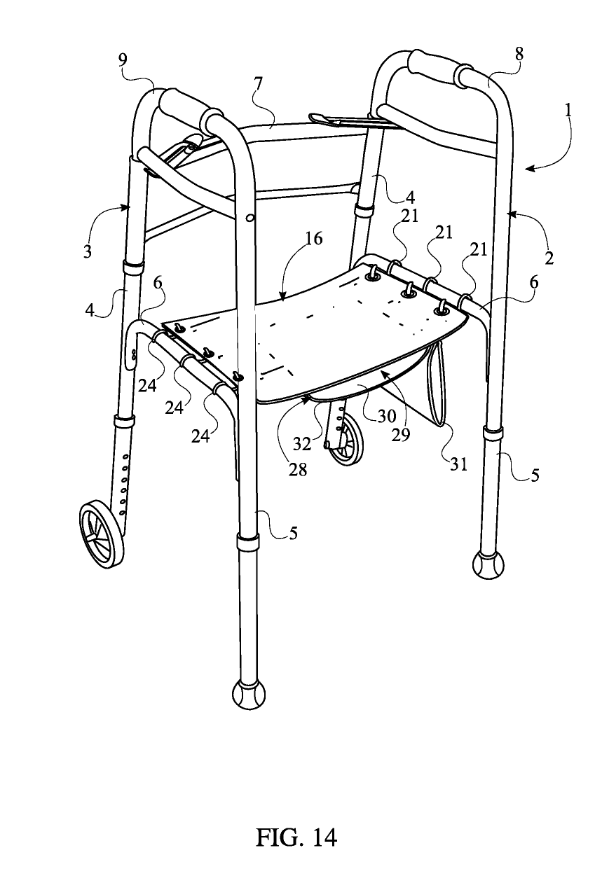

A flashlight is contained and positioned as the present invention further comprises a sleeve 31 with the storage compartment 30. The sleeve 31 suspends a flashlight and positions the flashlight such that the path of user with the present invention is effectively illuminated with the corresponding flashlight. In alternate embodiments of the present invention, the sleeve 31 may comprise a friction-inducing band that grasps onto the flashlight and prevents the flashlight from slipping past the sleeve 31. In order to suspend the flashlight without interfering with the opening 29 and the storage compartment 30, the sleeve 31 is connected across the first sheet 16. The sleeve 31 is preferably connected across the first sheet 16 with a seam, however alternate embodiments of the present invention may comprise a sleeve 31 that is connected across the first sheet 16 with a plurality of snap buttons. In a sixth embodiment of the present invention, the sleeve 31 is positioned adjacent and oriented parallel to the second edge 13, as shown in FIG. 13. Similarly, in a seventh embodiment of the present invention, the sleeve 31 is positioned adjacent and oriented parallel to the first edge 12, shown in FIG. 14. Both the sixth embodiment and the seventh embodiment effectively illuminate the path of the user with the present invention while effectively distributing the weight of the sleeve 31 and contents of the sleeve 31 across the first sheet 16. Moreover, the weight of the sleeve 31 and the flashlight does not further contribute to the weight of the storage sheet 28 and the items housed within the storage compartment 30.

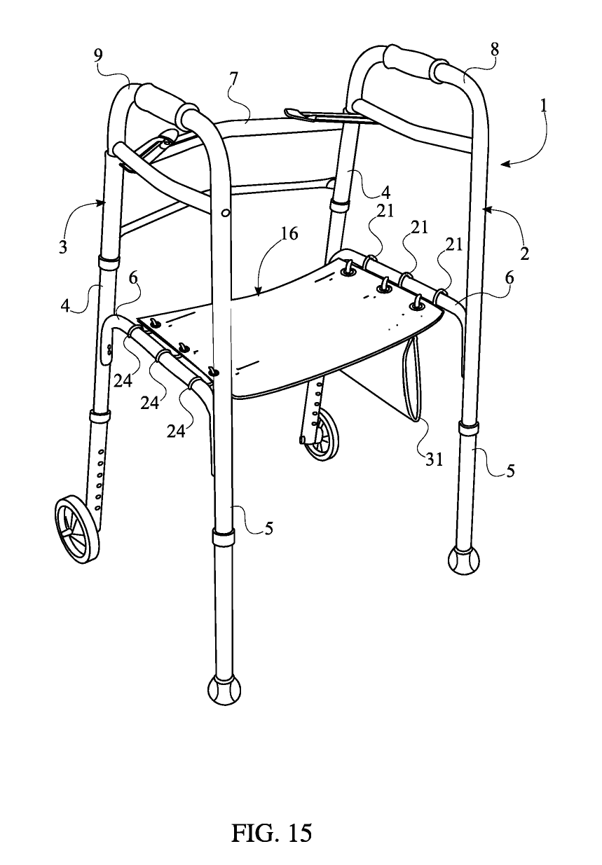

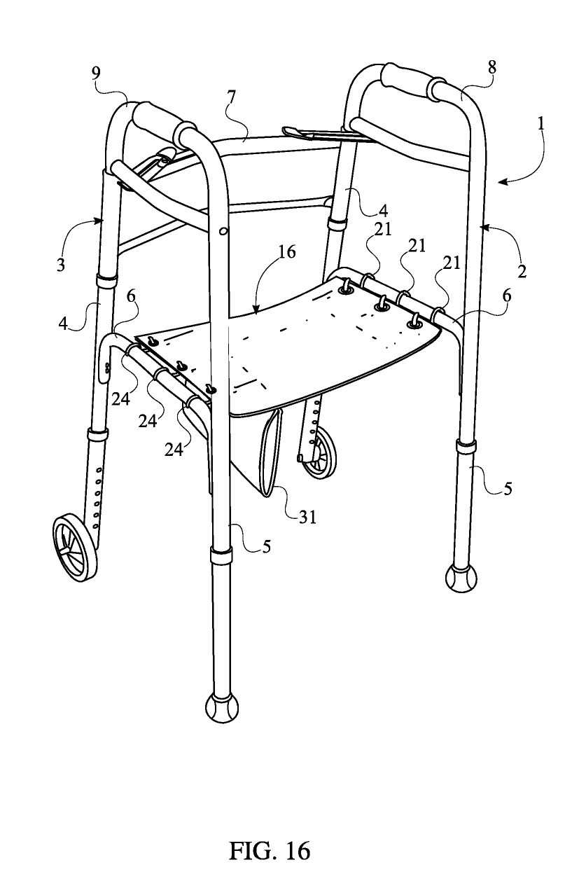

In an eighth embodiment and a ninth embodiment of the present invention, the present invention comprises a sleeve 31 only, with no storage sheet 28, seen in FIG. 15 and FIG. 16. In the eighth embodiment and the ninth embodiment the sleeve 31 is connected across the at least one suspending sheet 10. More specifically, for the eighth embodiment of the present invention, the sleeve 31 is positioned adjacent and oriented parallel to the second edge 13, seen in FIG. 16. Similarly, for the ninth embodiment of the present invention, the sleeve 31 is positioned adjacent and oriented parallel to the first edge 12, seen in FIG. 15. As in the sixth embodiment and the seventh embodiment, the eighth embodiment and the ninth embodiment effectively illuminate the path of the user with the present invention while effectively distributing the weight of the sleeve 31 and the contents of the sleeve 31 across the at least one suspending sheet 10.

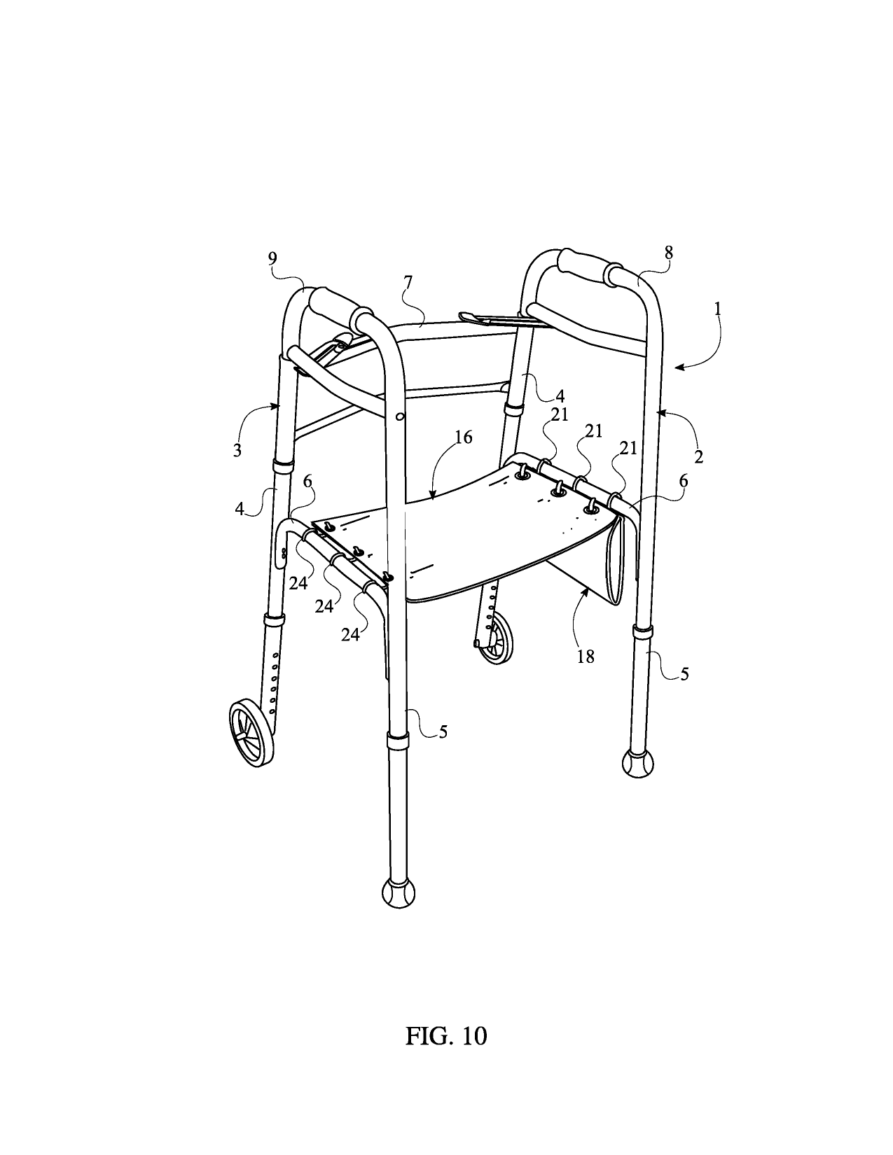

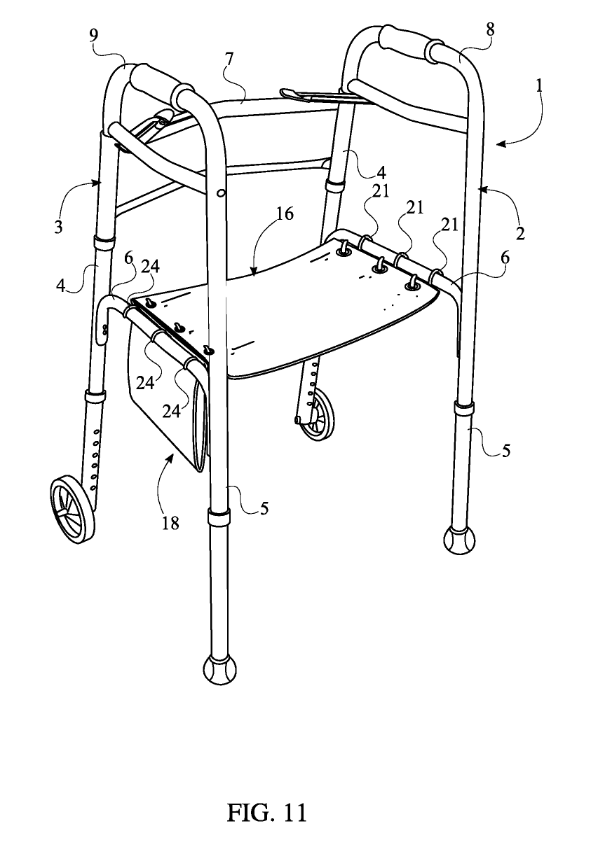

In a tenth embodiment and an eleventh embodiment of the present invention, the at least one suspending sheet 10 comprises a first sheet 16 and a second sheet 18 and the set of fasteners 20 comprises a plurality of first fasteners 21 and a plurality of second fasteners 24, wherein the second sheet 18 is utilized as a sleeve 31, similar to that of the sixth embodiment, the seventh embodiment, the eighth embodiment, and the ninth embodiment. The tenth embodiment is seen in FIG. 10 and the eleventh embodiment is seen in FIG. 11. In the tenth embodiment of the present invention, the first edge 12 of the second sheet 18 and the second edge 13 of the second sheet 18 is positioned adjacent to each other, shown in FIG. 10. A proximal end 22 of each first fastener is coupled to a corresponding hole of the plurality of first holes 14 of the first sheet 16. A proximal end 25 of each second fastener of the plurality of second fasteners 24 is coupled to a corresponding hole of the plurality of second holes 15 of the first sheet 16, a corresponding hole of the plurality of the first holes 14 of the second sheet 18, and a corresponding hole of the plurality of second holes 15 of the second sheet 18. This arrangement between the first sheet 16, the second sheet 18, the plurality of first fasteners 21, and the plurality of second fasteners 24 with each other allows the first sheet 16 to be in an expanded configuration and the second sheet 18 to be in a collapsed configuration as well as serve as a sleeve 31. In order for the first sheet 16 and the second sheet 18 to be connected to the folding walker 1, a distal end 23 of each first fastener of the plurality of first fasteners 21 is coupled to a support bar 6 of the first leg assembly 2, and a distal end 26 of each second fastener is couple to a support bar 6 of the second leg assembly 3. The arrangement of the ninth embodiment positions the second sheet 18 along the support bar 6 of the second leg assembly 3.

Similarly, in the eleventh embodiment of the present invention, the first edge 12 of the second sheet 18 and the second edge 13 of the second sheet 18 is positioned adjacent to each other, shown in FIG. 11. A proximal end 22 of each first fastener of the plurality of first fasteners 21 is coupled to a corresponding hole of the plurality of first holes 14 of the first sheet 16, a corresponding hole of the plurality of the first holes 14 of the second sheet 18, and a corresponding hole of the plurality of second holes 15 of the second sheet 18. A proximal end 25 of each second fastener is coupled to a corresponding hole of the plurality of second holes 15 of the first sheet 16. This arrangement between the first sheet 16, the second sheet 18, the plurality of first fasteners 21, and the plurality of second fasteners 24 with each other allows the first sheet 16 to be in an expanded configuration and the second sheet 18 to be in a collapsed configuration as well as serve as a sleeve 31. In order for the first sheet 16 and the second sheet 18 to be connected to the folding walker 1, a distal end 23 of each first fastener of the plurality of first fasteners 21 is coupled to a support bar 6 of the first leg assembly 2, and a distal end 26 of each second fastener of the plurality of second fasteners 24 is couple to a support bar 6 of the second leg assembly 3. The arrangement of the tenth embodiment positions the second sheet 18 along the support bar 6 of the first leg assembly 2.

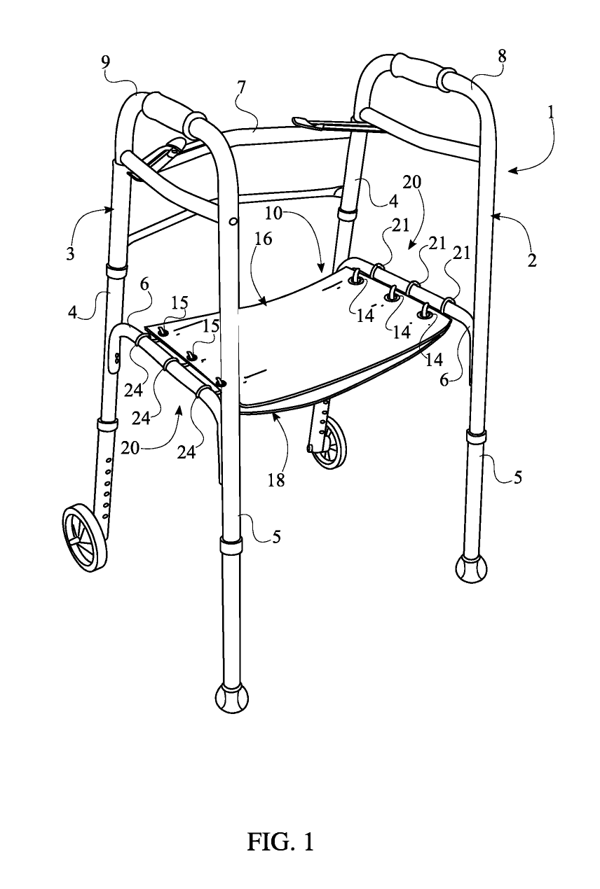

In a twelfth embodiment of the present invention, the at least one suspending sheet 10 also comprises a first sheet 16 and a second sheet 18, and the set of fasteners 20 also comprises a plurality of first fasteners 21 and a plurality of second fasteners 24. In the eleventh embodiment, both the first sheet 16 and the second sheet 18 traverse from the first leg assembly 2 to the second leg assembly 3, as seen in FIG. 1 and FIG. 2. The twelfth embodiment allows the at least one suspending sheet 10 to independently uphold a user that is sitting on the first sheet 16 and uphold the variety of items with the second sheet 18. Moreover, the first sheet 16 is positioned atop the second sheet 18. In order for both the first sheet 16 and the second sheet 18 to traverse across the folding walker 1, a proximal end 22 of each first fastener of the plurality of first fasteners 21 is coupled to a corresponding hole of the plurality of first holes 14 of the first sheet 16 and a corresponding hole of the plurality of first holes 14 of the second sheet 18. Similarly, a proximal end 25 of each second fastener of the plurality of second fasteners 24 is coupled to a corresponding hole of the plurality of second holes 15 of the first sheet 16 and a corresponding hole of the plurality of second holes 15 of the second sheet 18. Both the first sheet 16 and the second sheet 18 are suspended from the folding walker 1 as a distal end 23 of each first fastener of the plurality of first fasteners 21 is coupled to a support bar 6 of the first leg assembly 2, and a distal end 26 of each second fastener of the plurality of second fasteners 24 is being coupled to a support bar 6 of the second leg assembly 3.

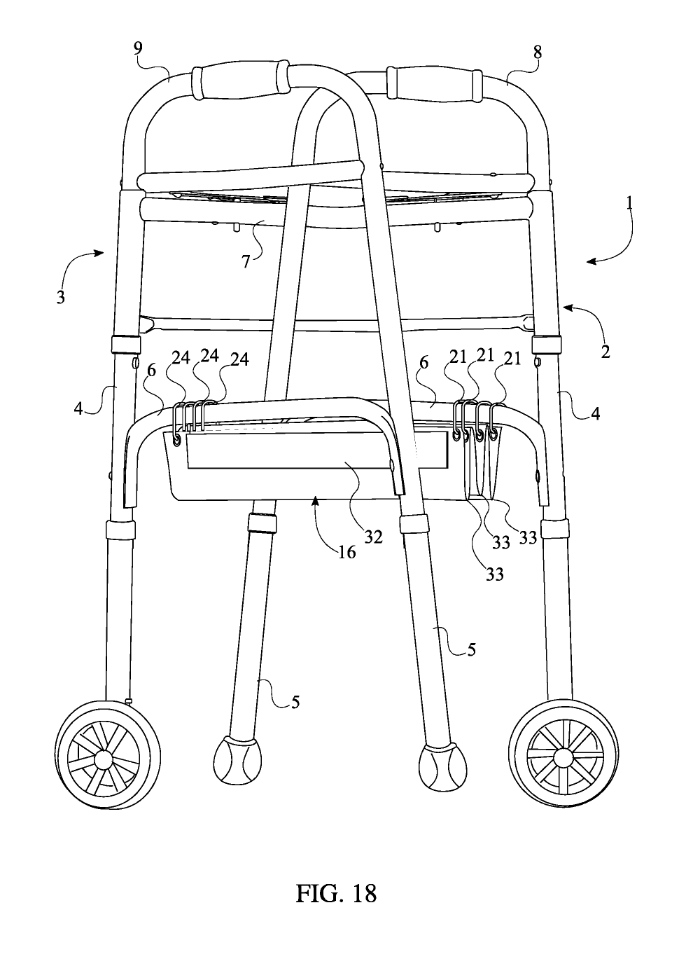

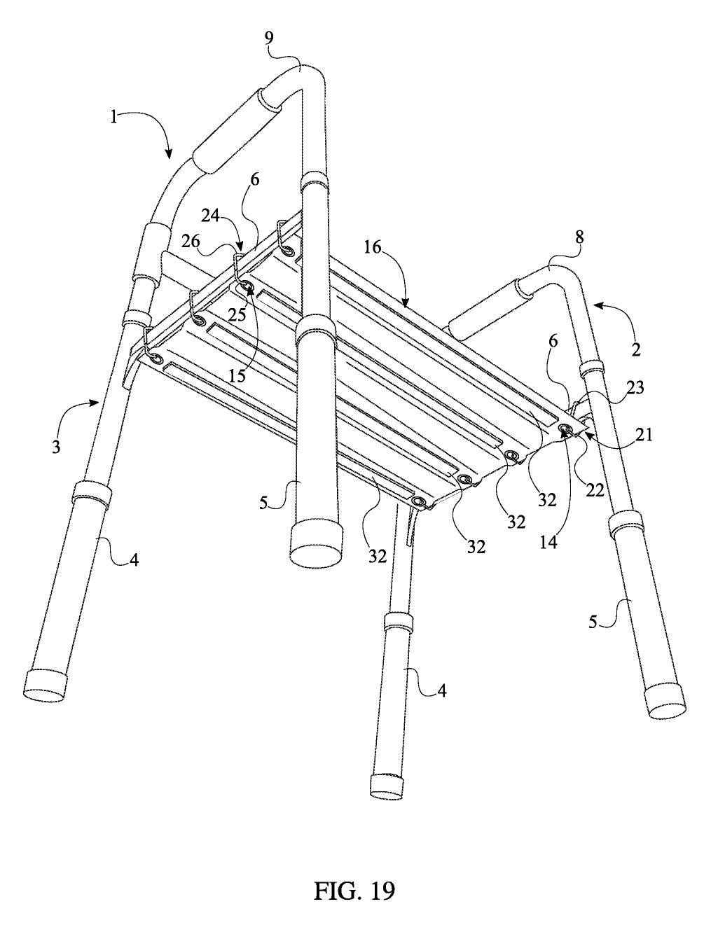

A thirteenth embodiment of the present invention and a fourteenth embodiment of the present invention each comprises a plurality of stabilizing panels 32. The plurality of stabilizing panels 32 reinforces the support of the at least one suspending sheet 10 against the weight of a user. In the thirteenth embodiment of the present invention, the at least one suspending sheet 10 comprises a first sheet 16, and the set of fasteners 20 comprises a plurality of first fasteners 21 and a plurality of second fasteners 24, seen in FIG. 18 and FIG. 19. In order to support the weight of the user against the entirety of the first sheet 16, the plurality of stabilizing panels 32 is distributed across the first sheet 16 and is fixed to the first sheet 16. The plurality of stabilizing panels 32 is preferably positioned across a first surface of the first sheet 16. The first surface is positioned opposite the second surface of the first sheet 16. Moreover, the first surface is oriented opposite the first armrest 9. Each stabilizing panel of the plurality of stabilizing panels 32 laterally traverses along the first sheet 16, between the plurality of first holes 14 and the plurality of second holes 15 in order to so that the force of the weight of the user against the first sheet 16 is evenly distributed across the length of the first sheet 16.

The thirteenth embodiment is able to uphold a user with the first sheet 16 and the first sheet 16 is able to remain attached to the folding walker 1 while in the collapsed configuration as the thirteenth embodiment further comprises a plurality of folding edges 33, seen in FIG. 18. The plurality of folding edges 33 allows the first sheet 16 to collapse and orients each of the plurality of stabilizing panels 32 parallel with each other. The plurality of folding edges 33 laterally traverses the sheet body 11 from the first edge 12 to the second edge 13. In order for the first sheet 16 and the plurality of stabilizing panels 32 to be compact while in the collapsed configuration, each of the folding edges of the plurality of folding edges 33 is positioned in between a stabilizing panel and an adjacent stabilizing panel of the plurality of stabilizing panels 32.

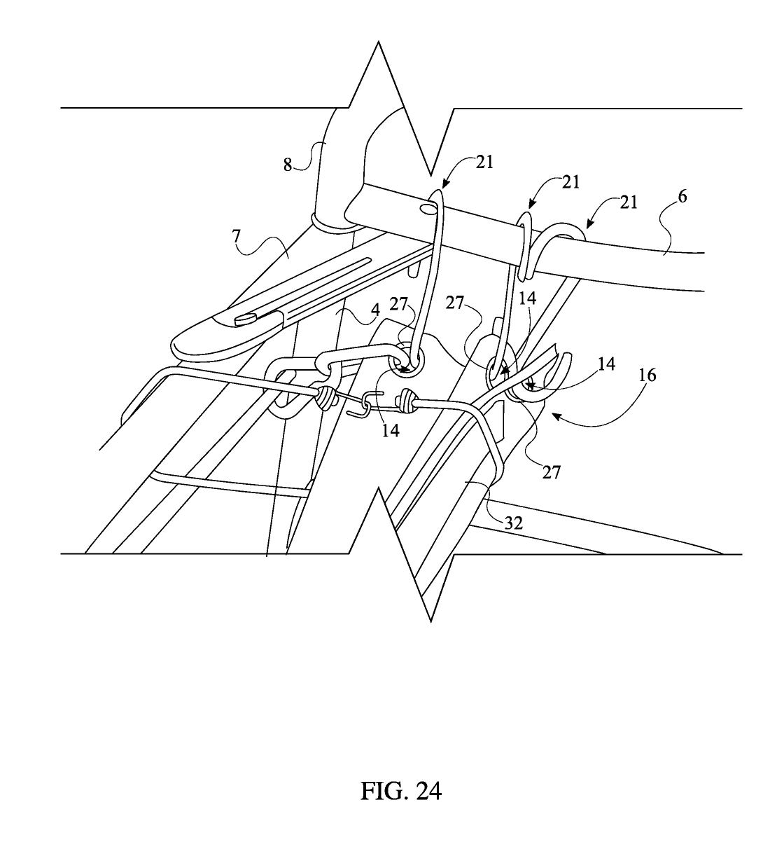

In order for the first sheet 16 of the thirteenth embodiment of the present invention to be secured in the collapsed configuration, the thirteenth embodiment of the present invention further comprises at least one first elongated band and a third fastener, seen in FIG. 24. The elongated band connects the first sheet 16 to the brace 7 so that the first sheet 16 remains in the collapsed configuration while the first leg assembly 2 and the second leg assembly 3 are extended. A user may lean on the first armrest 8 and the second armrest 9 while walking with the folding walker 1 as the first sheet 16 is collapsed against and along the brace 7 from the first leg assembly 2 and the second leg assembly 3 with the elongated band. Moreover, the plurality of first fasteners 21 and the plurality of second fasteners 24 may remain connected to the first leg assembly 2 and the second leg assembly 3, respectively, while the first sheet 16 is collapsed and compressed along the brace 7 and while the folding walker 1 is used as a walking aid. A first end of the elongated band is removably attached to a second end of the elongated band with the third fastener. A loop is defined by the at least one first elongated band with the third fastener. A rear edge of the first sheet 16 is positioned opposite the front edge 17 of the first sheet 16, across the first sheet 16. While in the collapsed configuration, the rear edge of the first sheet 16 is positioned adjacent the front edge 17 of the first sheet 16 and the first sheet 16 is folded along and across each folding edge of the plurality of folding edges 33. The first sheet 16 and the brace 7 are positioned within the loop.

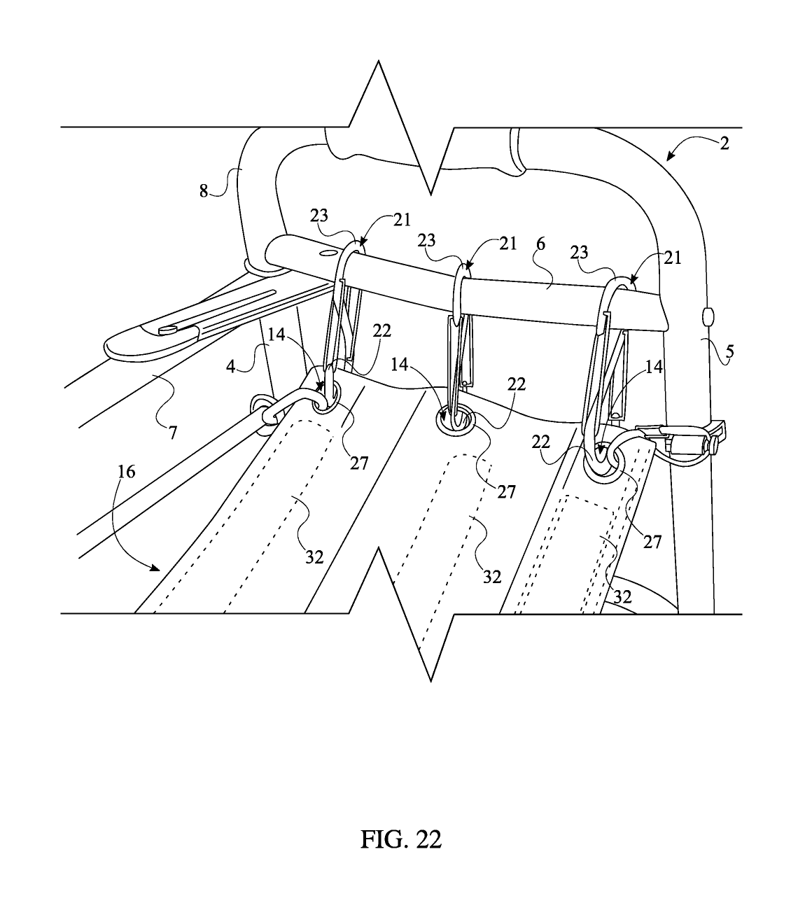

In order for the first sheet 16 of the thirteenth embodiment of the present invention to be secured in an expanded configuration, the thirteenth embodiment of the present invention further comprises a first front fastener, a first rear fastener, a second front fastener, a second rear fastener, a first tab, and a second tab, seen in FIG. 22. The first front fastener and the first rear fastener preserve the expanded configuration along the support bar 6 of the first leg assembly 2. Similarly, the second front fastener and the second rear fastener preserve the expanded configuration along the support bar 6 of the second leg assembly 3. The first tab fixes the position of the first rear fastener along the second leg 5 of the first leg assembly 2, and the second tab fixes the position of the second rear fastener along the second leg 5 of the second leg assembly 3. The first sheet 16 is connected to the brace 7, as the first front fastener is coupled with a first hole of the plurality of first holes positioned adjacent the front edge 17 of the first sheet 16 and the brace 7. Similarly, the second front fastener is coupled with a second hole of the plurality of second holes positioned adjacent the front edge 17 of the first sheet 16. The first tab is mounted with the second leg 5 of the first leg assembly 2, and the second tab is mounted with the second leg 5 of the second leg assembly 3, preferably with a clamp. The first sheet 16 is connected to the first tab, as the first rear fastener is coupled with a first hole of the plurality of first holes 14 positioned adjacent the rear edge of the first sheet 16 and the first tab. Similarly, the first sheet 16 is connected to the second tab, as the second rear fastener is coupled with a second hole of the plurality of second holes 15 positioned adjacent the rear edge of the first sheet 16 and second tab.

The thirteenth embodiment is able to support a user with the folding walker 1 as a proximal end 22 of each first fastener of the plurality of first fasteners 21 is coupled to a corresponding hole of the plurality of first holes 14 of the first sheet 16, seen in FIG. 19. Similarly, a proximal end 25 of each second fastener of the plurality of second fasteners 24 is coupled to a corresponding hole of the plurality of second holes 15 of the first sheet 16. The first sheet 16 hangs from the folding walker 1 as a seat for the user as a distal end 23 of each first fastener of the plurality of first fasteners 21 is coupled to a support bar 6 of the first leg assembly 2. Similarly, a distal end 26 of each second fastener of the plurality of second fasteners 24 is coupled to a support bar 6 of the second leg assembly 3.

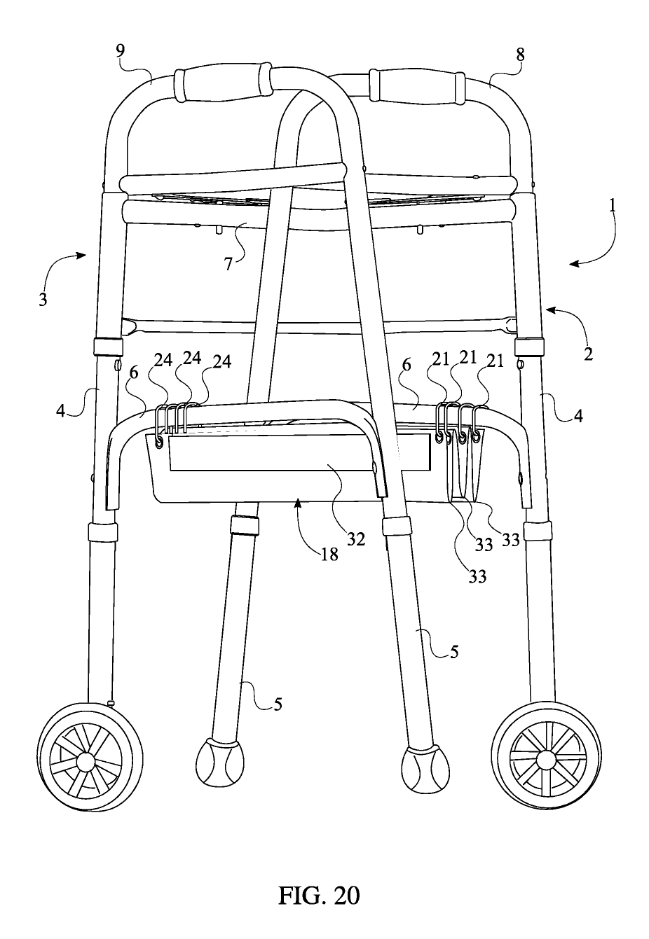

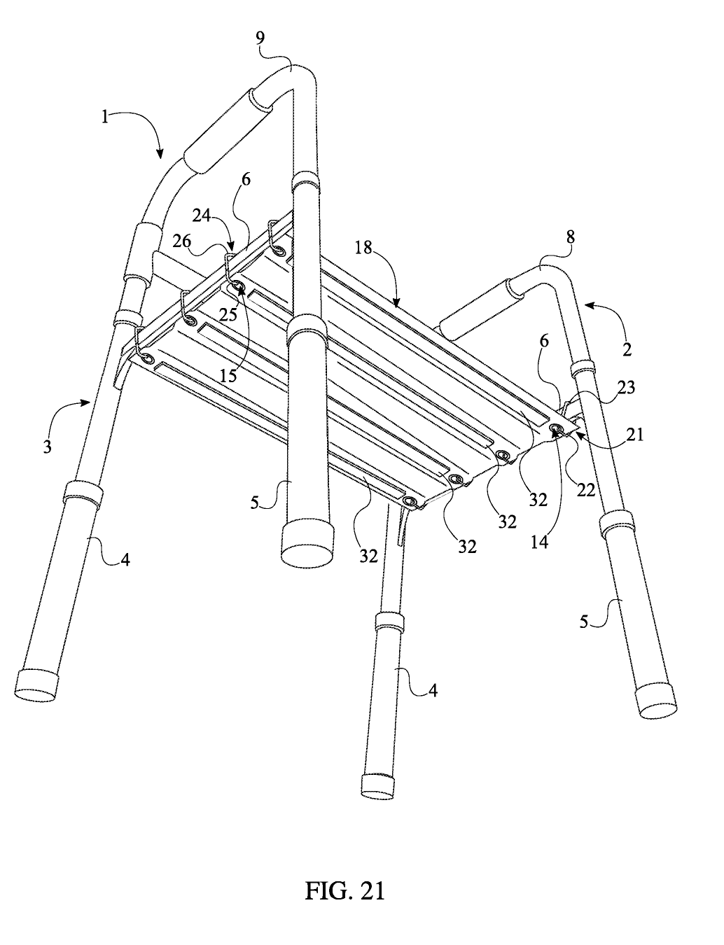

In the fourteenth embodiment of the present invention, the at least one suspending sheet 10 comprises a second sheet 18, and the set of fasteners 20 comprises a plurality of first fasteners 21 and a plurality of second fasteners 24, seen in FIG. 20 and FIG. 21. In order to support the weight of the user against the entirety of the second sheet 18, the plurality of stabilizing panels 32 is distributed across the second sheet 18 and is fixed to the second sheet 18. The plurality of stabilizing panels 32 is preferably positioned across a first surface of the second sheet 18. The first surface is positioned opposite the second surface of the second sheet 18. Moreover, the first surface is oriented opposite the first armrest 9. Each stabilizing panel of the plurality of stabilizing panels 32 laterally traverses along the second sheet 18, between the plurality of first holes 14 and the plurality of second holes 15 in order to so that the force of the weight of the user against the second sheet 18 is evenly distributed across the length of the second sheet 18.

The fourteenth embodiment is able to uphold a user with the second sheet 18 and the second sheet 18 is able to remain attached to the folding walker 1 while in the collapsed configuration as the fourteenth embodiment further comprises a plurality of folding edges 33, seen in FIG. 20. The plurality of folding edges 33 allows the second sheet 18 to collapse and orients each of the plurality of stabilizing panels 32 parallel with each other. The plurality of folding edges 33 laterally traverses the sheet body 11 from the first edge 12 to the second edge 13. In order for the second sheet 18 and the plurality of stabilizing panels 32 to be compact while in the collapsed configuration, each of the folding edges of the plurality of folding edges 33 is positioned in between a stabilizing panel and an adjacent stabilizing panel of the plurality of stabilizing panels 32.

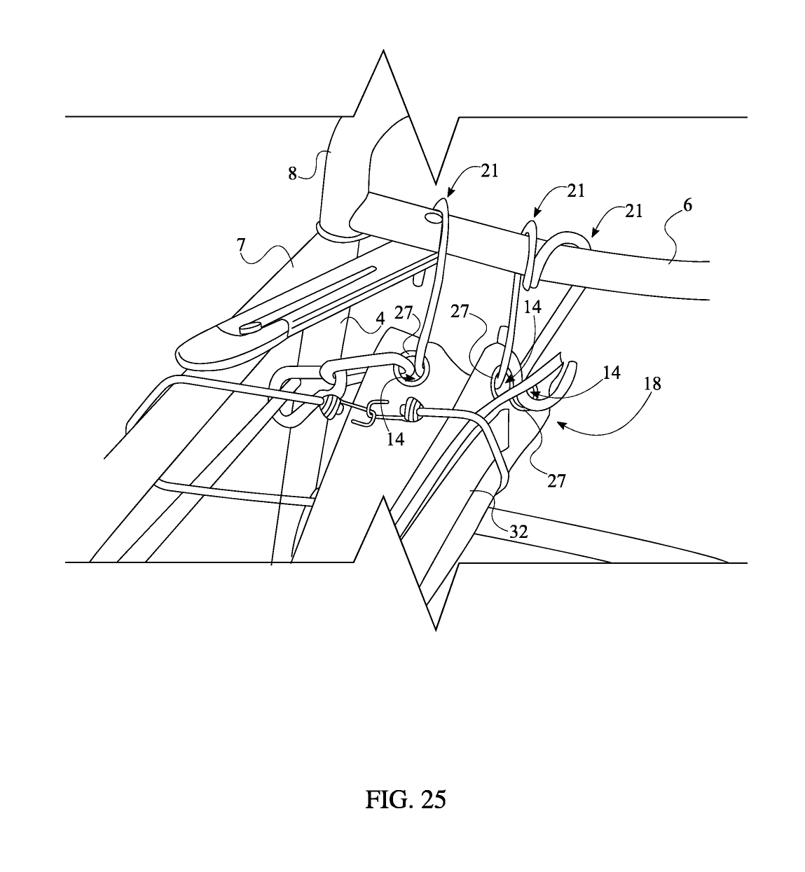

In order for the second sheet 18 of the fourteenth embodiment of the present invention to be secured in the collapsed configuration, the fourteenth embodiment of the present invention further comprises at least one second elongated band and a fourth fastener, FIG. 25. The at least one second elongated band connects the second sheet 18 to the brace 7 so that the second sheet 18 remains in the collapsed configuration while the first leg assembly 2 and the second leg assembly 3 are extended. A user may lean on the first armrest 8 and the second armrest 9 while walking with the folding walker 1 as the second sheet 18 is collapsed against and along the brace 7 from the first leg assembly 2 and the second leg assembly 3 with the elongated band. Moreover, the plurality of first fasteners 21 and the plurality of second fasteners 24 may remain connected to the first leg assembly 2 and the second leg assembly 3, respectively, while the second sheet 18 is collapsed and compressed along the brace 7 and while the folding walker 1 is used as a walking aid A first end of the at least one second elongated band is removably attached to a second end of the elongated band with the third fastener. A loop is defined by the at least one second elongated band with the fourth fastener. A rear edge of the second sheet 18 is positioned opposite the front edge 17 of the first sheet 16, across the second sheet 18. While in the collapsed configuration, the rear edge of the second sheet 18 is positioned adjacent the front edge 17 of the second sheet 18 and the second sheet 18 is folded along and across each folding edge of the plurality of folding edges 33. The second sheet 18 and the brace 7 are positioned within the loop.

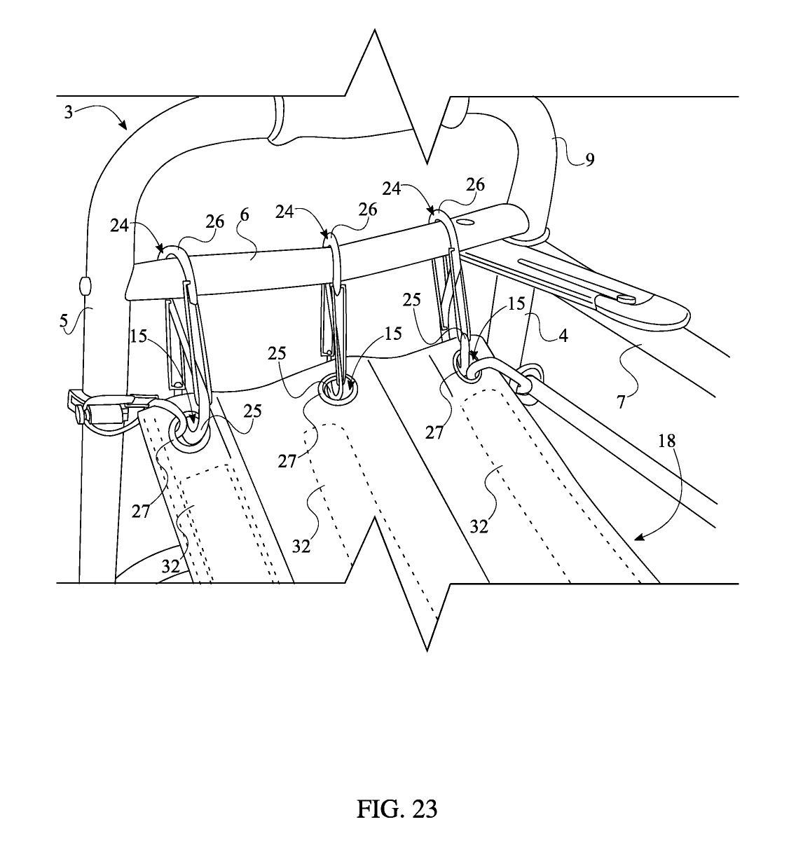

In order for the second sheet 18 of the fourteenth embodiment of the present invention to be secured in an expanded configuration, the fourteenth embodiment of the present invention further comprises a third front fastener, a third rear fastener, a fourth front fastener, a fourth rear fastener, a third tab, and a fourth tab, seen in FIG. 23. The third front fastener and the third rear fastener preserve the expanded configuration along the support bar 6 of the first leg assembly 2. Similarly, the fourth front fastener and the fourth rear fastener preserve the expanded configuration along the support bar 6 of the second leg assembly 3. The third tab fixes the position of the third rear fastener along the second leg 5 of the first leg assembly 2, and the fourth tab fixes the position of the fourth rear fastener along the second leg 5 of the second leg assembly 3. The second sheet 18 is connected to the brace 7, as the third front fastener is coupled with a first hole of the plurality of second holes 15 positioned adjacent the front edge 17 of the second sheet 18 and the brace 7. Similarly, the fourth front fastener is coupled with a second hole of the plurality of second holes 15 positioned adjacent the rear edge of the second sheet 18. The third tab is mounted with the second leg 5 of the first leg assembly 2, and the fourth tab is mounted with the second leg 5 of the second leg assembly 3, preferably with a clamp. The second sheet 18 is connected to the third tab, as the third rear fastener is coupled with a second hole of the plurality of second holes 15 positioned adjacent the rear edge of the second sheet 18 and the third tab. Similarly, the second sheet 18 is connected to the fourth tab, as the fourth rear fastener is coupled with a second hole of the plurality of second holes 15 positioned adjacent the rear edge of the second sheet 18 and fourth tab.

The fourteenth embodiment is able to support a user with the folding walker 1 as a proximal end 22 of each first fastener of the plurality of first fasteners 21 is coupled to a corresponding hole of the plurality of first holes 14 of the second sheet 18, seen in FIG. 21. Similarly, a proximal end 25 of each second fastener of the plurality of second fasteners 24 is coupled to a corresponding hole of the plurality of second holes 15 of the second sheet 18. The second sheet 18 hangs from the folding walker 1 as a seat for the user as a distal end 23 of each first fastener of the plurality of first fasteners 21 is coupled to a support bar 6 of the first leg assembly 2. Similarly, a distal end 26 of each second fastener of the plurality of second fasteners 24 is coupled to a support bar 6 of the second leg assembly 3.

Although the invention has been explained in relation to its preferred embodiment, it is to be understood that many other possible modifications and variations can be made without departing from the spirit and scope of the invention as hereinafter claimed.

What is claimed is:

1. A universal walker seat comprises:
a folding walker;
at least one suspending sheet;
a set of fasteners;
the folding walker comprises a first leg assembly, a second leg assembly, a brace, a first armrest, and a second armrest;
the at least one suspending sheet comprises a sheet body, a first edge, a second edge, a plurality of first holes, and a plurality of second holes;
the first armrest being mounted onto the first leg assembly;
the second armrest being mounted onto the second leg assembly;
the first leg assembly being foldably connected to the brace;
the second leg assembly being foldably connected to the brace, opposite the first leg assembly;
the first edge and the second edge being oppositely positioned of each other across the sheet body;
the plurality of first holes and the plurality of second holes traversing through the sheet body;
the plurality of first holes being distributed along the first edge of the sheet body;
the plurality of second holes being distributed along the second edge of the sheet body;
the set of fasteners being coupled to the plurality of first holes and the plurality of second holes; and,
the sheet body being attached to the folding walker with the set of fasteners.

2. The universal walker seat as claimed in claim 1 comprises:
the first leg assembly and the second leg assembly each comprises a first leg, a second leg, and a support bar;
the first leg being terminally fixed to the support bar;
the second leg being terminally fixed to the support bar, opposite the first leg;
the support bar being oriented perpendicular to the first leg and the second leg;
the support bar of the first leg assembly being positioned offset from the first armrest; and,
the support bar of the second leg assembly being positioned offset from the second armrest.

3. The universal walker seat as claimed in claim 1 comprises:
a plurality of grommets;
the plurality of grommets being mounted onto the sheet; and,
each grommet of the plurality of grommets being perimetrically positioned around a corresponding first hole of the plurality of first holes.

4. The universal walker seat as claimed in claim 1 comprises:
a plurality of grommets;
the plurality of grommets being mounted onto the sheet; and,
each grommet of the plurality of grommets being perimetrically positioned around a corresponding second hole of the plurality of second holes.

5. The universal walker seat as claimed in claim 1 comprises:
the set of fasteners comprises a plurality of first fasteners;
a proximal end of each first fastener being coupled to a corresponding hole of the plurality of first holes and a corresponding hole of the plurality of second holes; and,
a distal end of each first fastener being coupled to a support bar of the first leg assembly.

6. The universal walker seat as claimed in claim 5, wherein the at least one suspending sheet is a first sheet.

7. The universal walker seat as claimed in claim 5, wherein the at least one suspending sheet is a second sheet.

8. The universal walker seat as claimed in claim 1 comprises:
the set of fasteners comprises a plurality of second fasteners;
a proximal end of each second fastener being coupled to a corresponding hole of the plurality of first holes and a corresponding hole of the plurality of second holes; and,
a distal end of each second fastener being coupled to a support bar of the second leg assembly.

9. The universal walker seat as claimed in claim 8, wherein the at least one suspending sheet is a first sheet.

10. The universal walker seat as claimed in claim 8, wherein the at least one suspending sheet is a second sheet.

11. The universal walker seat as claimed in claim 1 comprises:
the set of fasteners comprises a plurality of first fasteners and a plurality of second fasteners;
a proximal end of each first fastener being coupled to a corresponding hole of the plurality of first holes;
a proximal end of each second fastener being coupled to a corresponding hole of the plurality of second holes;
a distal end of each of the plurality of first fastener being coupled to a support bar of the first leg assembly; and,
a distal end of each second fastener being coupled to a support bar of the second leg assembly.

12. The universal walker seat as claimed in claim 11, wherein the at least one suspending sheet is a first sheet.

13. The universal walker seat as claimed in claim 11, wherein the at least one suspending sheet is a second sheet.

14. The universal walker seat as claimed in claim 11 comprises:
a storage sheet;
an opening;
a storage compartment;
the storage sheet being perimetrically connected to the first sheet;
the opening being delineated by a front edge of the first sheet and a front edge of the storage sheet; and,
the storage compartment being delineated by the opening, the sheet body of the first sheet, and a sheet body of the storage sheet.

15. The universal walker seat as claimed in claim 13 comprises:
a sleeve;
the sleeve being connected across the first sheet; and,
the sleeve being positioned adjacent and oriented parallel to the second edge.

16. The universal walker seat as claimed in claim 13 comprises:
a sleeve;
the sleeve being connected across the first sheet; and,
the sleeve being positioned adjacent and oriented parallel to the first edge.

17. The universal walker seat as claimed in claim 11 comprises:
a sleeve;
the sleeve being connected across the at least one suspending sheet; and,
the sleeve being positioned adjacent and oriented parallel to the second edge.

18. The universal walker seat as claimed in claim 11 comprises:
a sleeve;
the sleeve being connected across the at least one suspending sheet; and,
the sleeve being positioned adjacent and oriented parallel to the first edge.

19. The universal walker seat as claimed in claim 1 comprises:
the at least one suspending sheet comprises a first sheet and a second sheet;
the set of fasteners comprises a plurality of first fasteners and a plurality of second fasteners;
the first edge of the second sheet and the second edge of the second sheet being positioned adjacent to each other;
a proximal end of each first fastener being coupled to a corresponding hole of the plurality of first holes of the first sheet;
a proximal end of each second fastener being coupled to a corresponding hole of the plurality of second holes of the first sheet, a corresponding hole of the plurality of first holes of the second sheet, and a corresponding hole of the plurality of second holes of the second sheet;
a distal end of each first fastener being coupled to a support bar of the first leg assembly; and,
a distal end of each second fastener being coupled to a support bar of the second leg assembly.

20. The universal walker seat as claimed in claim 1 comprises:
the at least one suspending sheet comprises a first sheet and a second sheet;
the set of fasteners comprises a plurality of first fasteners and a plurality of second fasteners;
the first edge of the second sheet and the second edge of the second sheet being positioned adjacent to each other;
a proximal end of each first fastener being coupled to a corresponding hole of the plurality of first holes of the first sheet, a corresponding hole of the plurality of first holes of the second sheet, and a corresponding hole of the plurality of second holes of the second sheet;
a proximal end of each second fastener being coupled to a corresponding hole of the plurality of second holes of the first sheet;
a distal end of each first fastener being coupled to a support bar of the first leg assembly; and,
a distal end of each second fastener being coupled to a support bar of the second leg assembly.

21. The universal walker seat as claimed in claim 1 comprises:
the at least one suspending sheet comprises a first sheet and a second sheet;
the set of fasteners comprises a plurality of first fasteners and a plurality of second fasteners;
the first sheet being positioned atop the second sheet;
a proximal end of each first fastener being coupled to a corresponding hole of the plurality of first holes of the first sheet and a corresponding hole of the plurality of first holes of the second sheet;
a proximal end of each second fastener being coupled to a corresponding hole of the plurality of second holes of the first sheet and a corresponding hole of the plurality of second holes the second sheet;
a distal end of each first fastener being coupled to a support bar of the first leg assembly; and,
a distal end of each second fastener being coupled to a support bar of the second leg assembly.

22. The universal walker seat as claimed in claim 1 comprises:
a plurality of stabilizing panels;
the at least one suspending sheet comprises a first sheet;
the set of fasteners comprises a plurality of first fasteners and a plurality of second fasteners;
the plurality of stabilizing panels being distributed across the first sheet;
the plurality of stabilizing panels being fixed to the first sheet; and,
each stabilizing panel of the plurality of stabilizing panels laterally traversing along the first sheet, between the plurality of first holes and the plurality of second holes.

23. The universal walker seat as claimed in claim 22 comprises:
the first sheet comprises a plurality of folding edges;
the plurality of folding edges laterally traversing the sheet body from the first edge to the second edge; and,
each of the folding edges of the plurality of folding edges being positioned in between a stabilizing panel and an adjacent stabilizing panel of the plurality of stabilizing panels.

24. The universal walker seat as claimed in claim 22 comprises:
a proximal end of each first fastener being coupled to a corresponding hole of the plurality of first holes of the first sheet;
a proximal end of each second fastener being coupled to a corresponding hole of the plurality of second holes of the first sheet;
a distal end of each first fastener being coupled to a support bar of the first leg assembly; and,
a distal end of each second fastener being coupled to a support bar of the second leg assembly.

25. The universal walker seat as claimed in claim 1 comprises:
a plurality of stabilizing panels;
the at least one suspending sheet comprises a second sheet;
the set of fasteners comprises a plurality of first fasteners and a plurality of second fasteners;
the plurality of stabilizing panels being distributed across the second sheet;
the plurality of stabilizing panels being fixed to the second sheet; and,
each stabilizing panel of the plurality of stabilizing panels laterally traversing along the second sheet, between the plurality of first holes and the plurality of second holes.

26. The universal walker seat as claimed in claim 25 comprises:
the second sheet comprises a plurality of folding edges;
the plurality of folding edges laterally traversing the sheet body from the first edge to the second edge; and,
each of the folding edges of the plurality of folding edges being positioned in between a stabilizing panel and an adjacent stabilizing panel of the plurality of stabilizing panels.

27. The universal walker seat as claimed in claim 25 comprises:
a proximal end of each first fastener being coupled to a corresponding hole of the plurality of first holes of the second sheet;
a proximal end of each second fastener being coupled to a corresponding hole of the plurality of second holes of the second sheet;
a distal end of each first fastener being coupled to a support bar of the first leg assembly; and,
a distal end of each second fastener being coupled to a support bar of the second leg assembly.
